(19) United States
(12) Patent Application Publication
(10) Pub. No.: US 2012/0143696 A1
(43) Pub. Date: Jun. 7, 2012

(54) USER BASED SELECTION OF ADVERTISEMENTS

(76) Inventors: Sudhir KAUSHIK, Sunnyvale, CA (US); Danielle BARBIERI, San Jose, CA (US)

(21) Appl. No.: 12/962,221

(22) Filed: Dec. 7, 2010

(51) Int. Cl. G06Q 30/00

(52) U.S. Cl. 705/14.66

(57) ABSTRACT

Techniques are described which allow users to control the nature of ads that are presented during a viewing session in real-time, i.e., depending on their current viewing situation. For example, users may dynamically specify certain preferences depending on their current viewing situation, such as “watching alone” or “with a child,” etc. Doing so allows consumers to make real-time selections of the nature and category of advertisements presented when consuming advertising-supported media content, e.g., when viewing media from video-streaming service using a set-top cable box or home theater PC.

### TECHNICAL FIELD

Embodiments presented in this disclosure generally relate to advertising networks. More specifically, embodiments presented herein relate to user based selection of advertisements, for both online and televised content, based on ratings and categories.

### BACKGROUND

One issue that affects consumer perception (and response) to both online and televised advertisements is that advertising platforms and networks have very little knowledge of “who is the room.” Currently, there is no mechanism for viewers to specify real time selections of the nature of advertisements that should be displayed based on who is viewing televised or online content. For example, while viewing a program using a streaming media device or set-top cable box (generally referred to as video on-demand), viewers may be presented with interstitial advertisements selected by an ad server, without regard for the viewer's preferences or who is then presently viewing the streaming media title. Similarly, many DVR (digital video recorder systems) allow users to record and playback television programs along with the interstitial advertisements (i.e., the commercial breaks in a broadcast program). In some cases, this leads to users being presented with inappropriate or offensive ad selections, or ads that are simply irrelevant to a particular viewer. For example, assume a parent is watching a football game (whether as broadcast live, as a video on demand presentation, or as a DVR recording), and their child walks into the room. The parent may consider the advertisements presented during the game to be inappropriate for the child (e.g., advertisements for violent video games, or alcoholic beverages, etc.), but has no convenient mechanism to prevent such advertisements from being presented.

Further, so-called “home-theater PCs” (HTPCs) have become a popular addition to many households. An HTPC generally connects a computer to a television set—allowing a variety of internet-based media to be presented, e.g., in a family living room. And a variety of software is available for playing streaming media or recorded content using an HTPC. Accordingly, the same scenario can occur for online content, where an adult is viewing online content (e.g., using a streaming medial or video on demand service) and a child walks into the room with a computer system. As with a set-top-box or cable-box, there is no mechanism for specifying in real-time that only age appropriate advertisements should be selected be sent by an ad server while an adult views content online or via an HTPC, in particular, or for specifying advertising preferences in real-time, in general.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example computing infrastructure used to provide advertising content to different client systems, according to certain embodiments of the present disclosure.

FIG. 2 illustrates an example computing system used to provide an advertising network, according to certain embodiments of the present disclosure.

FIG. 3 illustrates an example of a computing system used view online content, according to certain embodiments of the present disclosure.

FIG. 4 is a block diagram illustrating components of a cable set-top-box or digital video recorder (DVR), according to certain embodiments of the present disclosure.

FIG. 5 illustrates a method for a client device to govern preferences for advertisements presented while presenting other media content, according to certain embodiments of the present disclosure.

FIG. 6 illustrates a method for an ad server platform to dynamically select an advertisement to present to a user during content playback, according to certain embodiments of the present disclosure.

FIG. 7 illustrates an example of a web-based interface used to specify real-time advertising preferences, according to certain embodiments of the present disclosure.

### DESCRIPTION

### Overview

Embodiments presented herein relate to techniques for users to specify advertising preferences, for both online and televised content, in real-time based on ratings and categories. One embodiment provides a method. The method may generally include, during a viewing session for presenting media content to a user, receiving an indication of preferences for advertisements to be presented during the viewing session. This method may also include receiving a request for an advertisement to present to the user, selecting, based on the received preferences, a first advertisement to present to the user, and causing the first advertisement to be returned to a client device.

Additional embodiments include a computer readable storage medium, storing computer-executable instructions configured to perform the aforementioned method, and a system having a processor and a memory storing a program configured to perform the aforementioned method.

### Description of Example Embodiments

Embodiments described herein provide users with greater control over the categories or content of advertising presented during a viewing session in real-time. For example, users may dynamically specify certain preferences depending on their current (or projected) viewing situation, such as “watching alone” or “with a child,” etc. Thus, embodiments described herein allow consumers to make real-time selections of the nature and category of advertisements presented when consuming advertising-supported media content, e.g., when viewing media from video-streaming service using a set-top cable box or home theater PC (HTPC).

In one embodiment, a user-interface on a content-publisher website (or interface provided by a cable set-top-box or DVR) may include a control that allows the user to indicate the nature of ads that should be presented during a viewing session. For example, assume a user visits a content provider's website to consume/watch content (e.g., a website hosted by a streaming media provider). In such a case, the user may indicate the type of ads that should appear on the site during content playback. For example, the interface could allow a user to specify a content rating (e.g., using a scheme similar to the MPAA or other rating standards). Similarly, the user could also specify a vertical category (e.g., food, electronics, toys etc.). In such a case, the content provider may have an initial list of categories and/or ratings based on the specific content of the ads available from a given ad server network.

As noted, the user may specify such preferences for a given viewing session. In one embodiment, the user selections may be passed in real-time to the content publisher website or ad serving platform (e.g., as key/value pairs). The ad serving platform is configured to return appropriate ads back to the publisher site for presentment, based on the real-time preferences specified by the user. For example, the ad server may match key/value pairs or ad rating settings and return ads presented to the user consistent with the user's preferences. Note, user selections could indicate ratings and/or categories to include or exclude from being presented during a viewing session, depending on the particular implementation between the content provider and the ad server platform. Further, whether the real-time preferences are passed to the content provider or to the ad server platform directly may vary among implementations.

The user selections may be maintained for a given viewing session until the user decides to change them. For example, a parent watching streaming videos with a child could indicate this upon first visiting a content providing website, so only appropriate ads show up on the site during that session. However, if the child leaves the room, the user could then change the real-time preferences accordingly. Note, in the case of a website, where ads may be presented alongside content, the user's preference may be applied to all banner/rich media ads in the page and all the video ads served within the videos viewed in that viewing session. Similarly, in the case of streaming media supported by interstitial ads, the user's preferences could be applied to what ads are selected to be presented as part of a given “commercial break.” The application to cable television networks is similar, provided a cable box, set-top-box, or DVR provides two-way communication with a content provider, then ads may be selected based on real-time preferences specified using, e.g., the interface of such a cable-box or DVR (e.g., using a remote and an onscreen display).

Note, the following description is presented to enable one of ordinary skill in the art to make and use the proposed techniques. Descriptions of specific embodiments and applications are provided only as examples and various modifications will be readily apparent to those skilled in the art. The general principles described herein may be applied to other embodiments and applications without departing from the scope of the disclosure. Thus, the present disclosure is not to be limited to the embodiments shown, but is to be accorded the widest scope consistent with the principles and features described herein. For purpose of clarity, features relating to technical material that is known in the technical fields related to the proposed ideas have not been described in detail.

Further, embodiments are frequently described herein relative to online streaming video services where content is presented using a web-browser. However, one of ordinary skill in the art will recognize that embodiments of the disclosure may be adapted for a broad variety of advertising supported video content, including content distributed via online and other distribution networks (e.g., cable, satellite, mobile networks). Further still, one of ordinary skill in the art will recognize that embodiments of the disclosure may also be adapted for audio-only content, e.g., streaming internet radio services, where advertisements are either presented on a display screen or interstitial advertisements are presented as part of the audio stream.

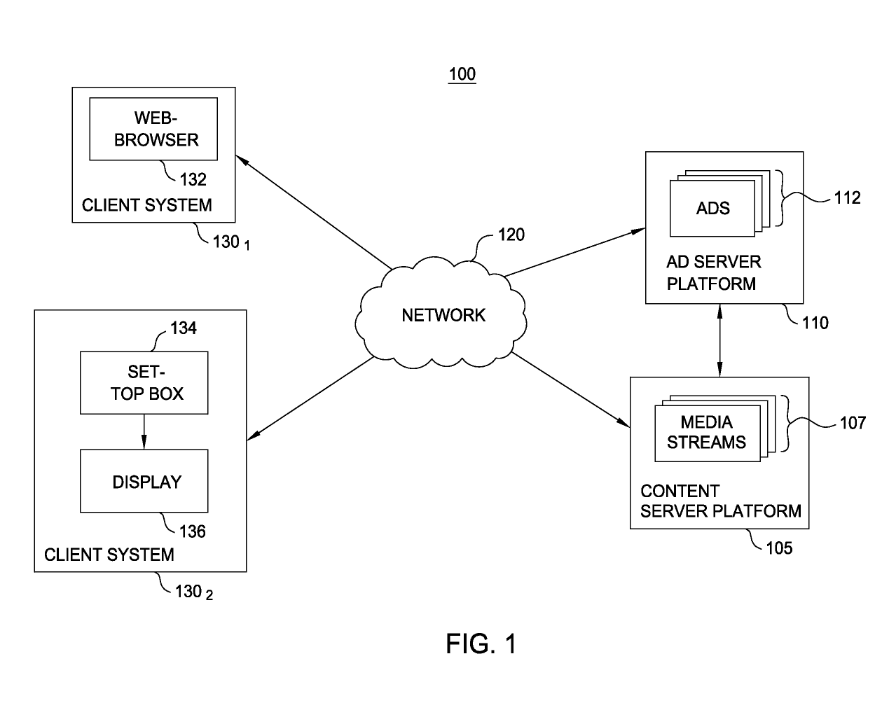

FIG. 1 illustrates an example computing infrastructure 100 used to provide both media and advertising content to different client systems 130, according to certain embodiments of the present disclosure. As shown, the computing infrastructure 100 includes a content server computer system 105, an ad server system 110 and a plurality of client systems 130₁₋₂, each connected to a communications network 120.

Illustratively, each of the client systems 130₁₋₂ communicates with the content server system 105 and the ad server system 110 over the network 120 to download both media content (shown as media streams 107) and advertisements presented with that content (shown as ads 112), whether presented alongside the content as in the case of a banner ad or as an interstitial ad interrupting general content playback. In this particular example, client system 130₁, represents a computer system running a web-browser 132. Accordingly, client system 130₁ is representative of desktop PCs, laptop computers, home-theater PCs, tablet computers and other computing systems capable of running a web-browser. In such a case, the web-browser 132 is configured to render web pages served from the content server platform 105. Such pages may allow users to select to view media streams 107 as well as specify preferences for advertising content 112 in real-time.

Similarly, client system 130₂ represents a set-top device connected to both network 120 and a display 124 (e.g., a flat-panel display). Accordingly, client system 130₂ is representative of digital cable boxes, digital video recorder (DVR) systems, and other specialized streaming media devices, as well as DVD players capable of connecting to a network 120 and receiving media streams 107 provided by content server platform 105. For example, some Blu-Ray® disc players can download and execute BD-live applications. In such a case, the disc player could connect to the content server 105 and download interface components used to select and playback media streams 107 as well as specify real-time preferences for advertisements 112 presented with the media streams 107. Further, display 134 may itself be an integrated device capable of connecting to the network 120 playing back media streams 107. For example, some flat-panel television displays include integrated firmware components used to connect to a variety of content server platforms 105 (e.g., various streaming media services, video on demand services, or popular video sharing websites). In each of these cases, the interface presented to users may allow users to both select content for playback (e.g., media streams 107) and specify preferences for advertisements (e.g., media streams 112) in real-time for a given viewing session.

Content server platform 105 provides a computing system configured to transmit media streams 107 to clients 130₁₋₂. For example, content server platform 107 may provide a web-server configured to respond to requests for web pages received from web-browser 132. Similarly, ad server platform 110 provides a computing system configured to respond to requests for ads delivered with the media streams 107. In one embodiment, ads may be served directly to a client system 130. For example, web-pages served by the content server platform 105 may include references to advertisements to be supplied by the ad server platform 110. In such a case, the real-time advertising preferences specified by a user may be transmitted to the ad server platform 110 when web-browser 132 requests an ad. Alternatively, the content server platform 105 may itself interact with the ad server platform 110 to retrieve and present an ad to the client system 130. In such a case, the then current advertising preferences for a given viewing session may be transmitted from a client system 130 to the content server platform 105. And in turn, the content server platform 105 can request (or filter for) an ad to present to the client system 130 that is consistent with the preferences of that viewing session. Further, in one embodiment, the ad server may be integrated as part of the streaming media service. In such a case, the content server platform may be configured to serve both media content as well as advertising content directly.

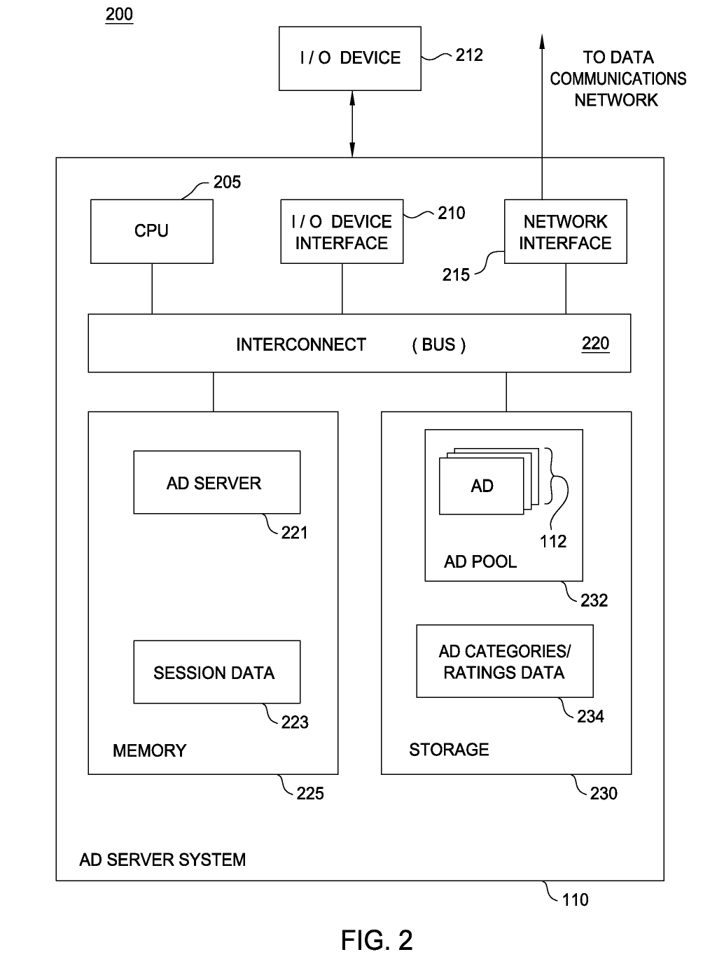

FIG. 2 illustrates an example ad server system 110, according to certain embodiments of the present disclosure. As shown, the server computing system 105 includes, without limitation, a central processing unit (CPU) 205, a network interface 215, an interconnect 220, a memory 225, and storage 230. The content server 105 may also include an I/O device interface 210 (e.g., keyboard, display and mouse devices).

The CPU 205 retrieves and executes programming instructions stored in the memory 225. Similarly, the CPU 205 stores and retrieves application data residing in the memory 225. The interconnect 220 facilitates transmission, such as of programming instructions and application data, between the CPU 205, I/O devices interface 210, storage 230, network interface 215, and memory 225. CPU 205 is included to be representative of a single CPU, multiple CPUs, a single CPU having multiple processing cores, and the like. And the memory 225 is generally included to be representative of a random access memory. The storage 230 may be a disk drive storage device. Although shown as a single unit, the storage 230 may be a combination of fixed and/or removable storage devices, such as fixed disc drives, floppy disc drives, tape drives, removable memory cards, or optical storage, network attached storage (NAS), or a storage area-network (SAN).

Illustratively, the memory 225 includes an ad server application 221 and session data 227, and storage 230 includes ad categories/ratings data 234 and an ad pool 232, which itself includes a collection of ads 112.

Ad server 221 may provide a software application configured to serve ads in response to requests from clients (e.g., client system 130₁ of FIG. 1) or in some cases from a media streaming system configured to request ads on behalf of clients. In one embodiment, the ad server 221 may receive and store session data 223 used to specify a given user's real-time preferences for a viewing session. Ad server 221 may then use the categories/ratings data 234 and the session data 223 to select an ad 112 from ad pool 232 that is consistent with a given user's real-time preferences. Advertisers typically produce advertisements provided to an ad network. The ad network is then compensated for presenting the ad to customers (e.g., on a pay-per-click, per view, or per impression basis etc.). Accordingly, ad pool 232 may include the entire collection of ads from different advertisers that are to be distributed using the ad server 221 as part of an ad network, some of which may be more (or less) appropriate or relevant to different consumers.

The ad categories/ratings data 234 is used to characterize ad content and/or the underlying products/services that are the subject of given ad 112. For example, like television programs, movies, video games, etc., advertisements may be assigned a rating to correspond to a generally appropriate age range (e.g., “everyone,” “teen” and “adult”). Similarly, vertical ad categories may specify market segments (e.g., food, electronics, toys, banking services, etc.) associated with a given ad 112. The session data 233 may be used to record a given user's real-time preferences for advertisements. Thus, when the ad server 221 receives a request to serve an ad 112 associated with that user's viewing session, the ad server 221 identifies the user's real-time preferences (if any) from session data 223 and then selects an ad from the ad pool 232 that is consistent with such preferences based on the ad categories/ratings data 234.

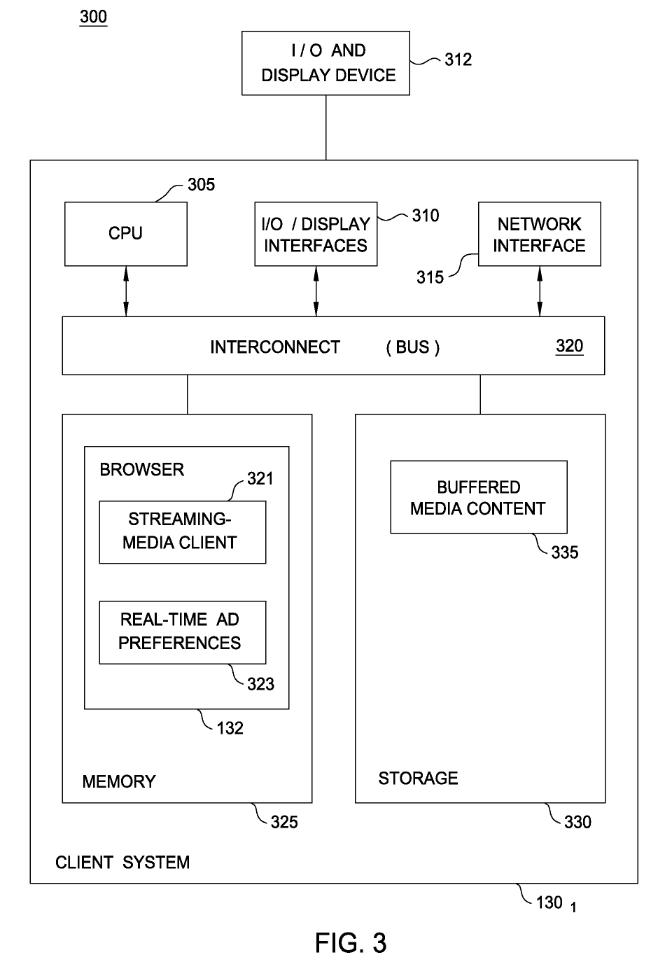

FIG. 3 illustrates an example of a client computing system 130₁ used view online content, according to certain embodiments of the present disclosure. As shown, the client computing system 130 includes, without limitation, a central processing unit (CPU) 305, a network interface 315, an interconnect 320, a memory 325, and storage 330. The computing system 130₁ may also include an I/O devices interface 310 connecting I/O devices 312 (e.g., keyboard, display and mouse devices) to the computing system 130₁.

Like CPU 205, CPU 306 is included to be representative of a single CPU, multiple CPUs, a single CPU having multiple processing cores, etc., and the memory 325 is generally included to be representative of a random access memory. The interconnect 320 is used to transmit programming instructions and application data between the CPU 305, I/O devices interface 310, storage 330, network interface 315, and memory 225. The network interface 315 is configured to transmit data via the communications network 120, e.g., to stream media from the server system 105, as well as to receive and present ads 112 from the ad server system 110. Storage 330, such as a hard disk drive or solid state (SSD) storage drive, may store non-volatile data.

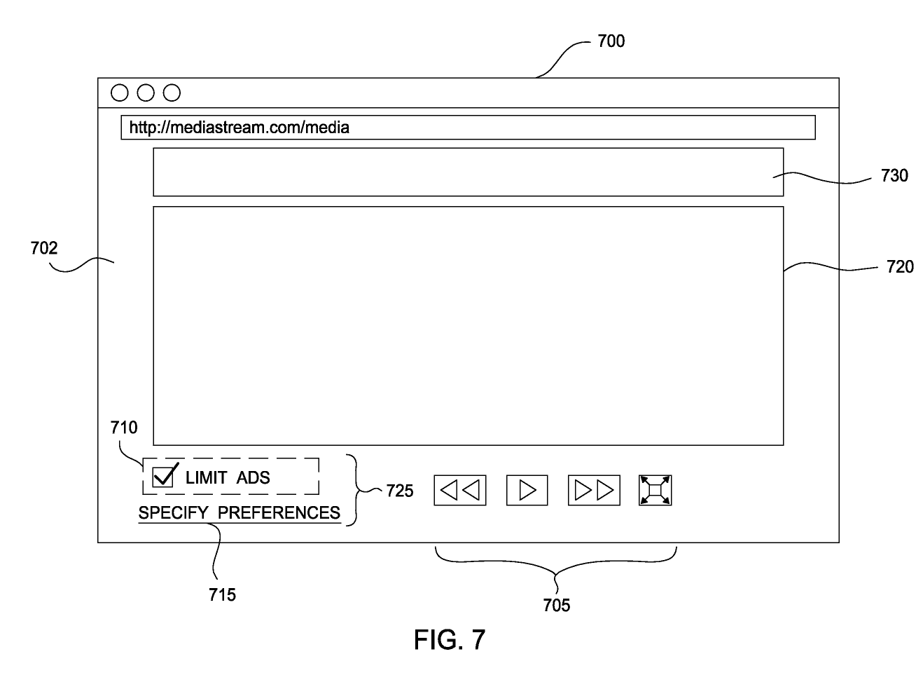

Illustratively, the memory 325 includes a web browser 132, which itself includes a streaming media client 321 and real-time ad preferences 323. And the storage 330 stores buffered media content 335. The browser 132 provides a software application which allows a user to access web pages and other content hosted by a server. In context of the present disclosure, the streaming media client 321 corresponds to components of browser 132 used to playback streaming media content, stored on client system 130₁ as buffered media content 355. For example, streaming media client 321 may be configured to playback media streams packaged as an Adobe® Flash® file, a Microsoft® Silverlight® package, or an HTML5 object. Additionally, the streaming media client 321 may also provide an interface which allows users to specify real-time preferences 323 during a viewing session. An example of such an interface is described below in conjunction with FIG. 7. Of course, other approaches may be used to allow the client system 130₁ to render a user interface, as well as to receive and present ads 112 from the ad server system 110.

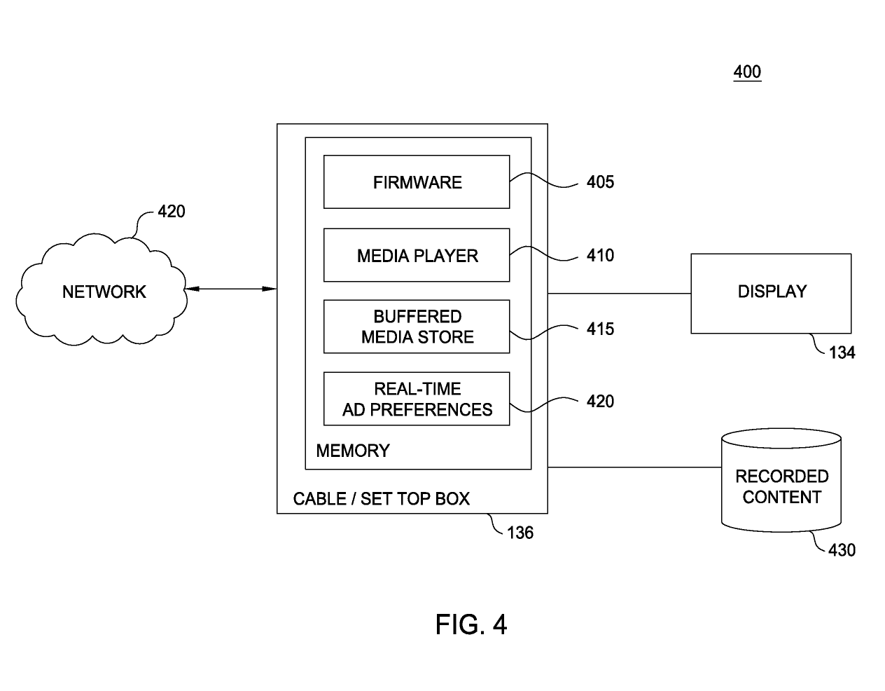

FIG. 4 is a block diagram illustrating components of a cable set-top-box, according to certain embodiments of the present disclosure. In this embodiment, a cable set-top box is connected to both a display screen (e.g., a flat panel television) and a network. Accordingly, as shown, a set-top box 136 is connected to both a network 425 and to a display 134. Note, set-top box 136 could also be a digital video recorder (DVR) device or a cable set-top box with integrated DVR functionality. Thus, set-top box 136 is also shown connected a storage repository of recorded content 430, representing locally stored content that is available for playback on display 134.

In one embodiment, the cable set-top box 136 is configured to present media content along with advertisements, where the advertisements may be selected based on the real-time preferences of a user specified during a viewing session. As shown, the set-top box 136 itself includes firmware 405, a media player 410, buffered media store 415 and real-time ad preferences 420. The firmware 405 represents the operating logic used to control the set-top box 136. For example, the firmware 405 may be configured to allow users to schedule recordings, connect to streaming media services, select content for playback, as well as provide user interfaces, including an interface to specify real-time ad preferences 420. Streaming media content retrieved over the network 420 may be stored in buffered media store 415. Media player 410 provides software on the set-top box 136 configured to playback content streamed over the network 420 or playback content from recorded content 430.

Further, the firmware 405 (or media player 410) may be configured to request advertisements to present to viewers during content playback. As noted above, such ads may be interstitial ads (i.e., commercial breaks), but could also be presented alongside content, e.g., as ads displayed as part of a content selection screen prior to (or following) media player 410 actually playing back content. Further still, recorded content 430 may include recordings of broadcast or televised programs. In one embodiment, the set-top box 136 may be configured to request advertisements to present when playing back such programs. For example, many DVR devices allow users to rapidly skip past commercials in recorded programs. In such a case, media player 410 may request ads in real-time from an ad server and present such ads overlaid on a display where a user skips through recorded content 430. Of course, one of ordinary skill in the art will recognize that set-top-box 136 may be configured in request ads in real-time from an ad server in a variety of other circumstances or scenarios. In each of these cases, the real-time ad preferences 420 may be used to govern what ads are presented during a given viewing session.

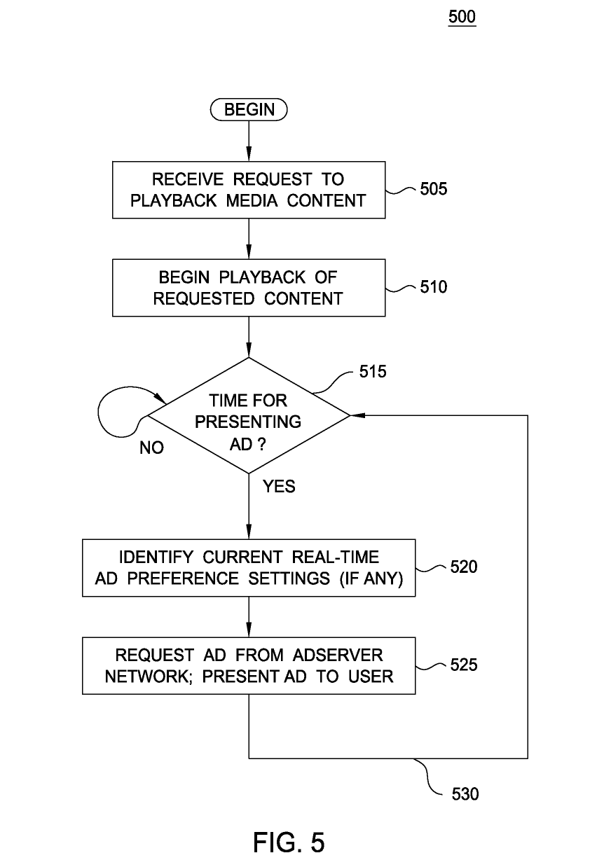

FIG. 5 illustrates a method 500 for a client system to govern preferences for advertisements presented while presenting other media content, according to certain embodiments of the present disclosure. As shown, the method 500 begins at step 505, where a user initiates a viewing session and requests to playback media content. As noted above, the request may be made by a user interacting with a web-browser or other application software on a computer (e.g., an HTPC), or interacting with a set-top box or a DVR device (or a device integrating components thereof). In one embodiment, the requested media content is streamed over a network to the client device, stored in a buffer, and then played back to the user. Alternatively, the content may have been previously recorded (or downloaded) to the client device and stored for future playback. In either case, at step 510, the client device begins playing the requested content.

At step 515, the client device waits for the appropriate time to present an advertisement. Note, as discussed above, ads may also be presented both prior to and following the playback of media content. At step 520, once the time for showing an advertisement is reached (e.g., as part of an interstitial break in content playback, or as part of a banner ad rendered alongside the playback of media content), the client device identifies the then current real-time ad preference settings specified by the viewer (if any). At step 525, the client device requests an ad from the ad server network and presents the ad to the user. Note, steps 520 and 525 may also be performed slightly prior to the time for actually presenting an ad, allowing the client device to obtain (or at least begin buffering) an advertisement from the ad server. In one embodiment, the client device supplies the then current real-time preferences for the viewing session as part of a given ad request. Alternatively, the ad request (and real-time preferences) may be submitted to a streaming media service directly, which then provides an ad back to the client device for presentment. The method 500 then returns to step 515 to wait until again reaching a time to present an ad to the user. For example, the client device may continue playing back content until reaching a time for inserting an interstitial ad or until reaching a time to rotate out ads presented in a banner ad alongside the streaming media content.

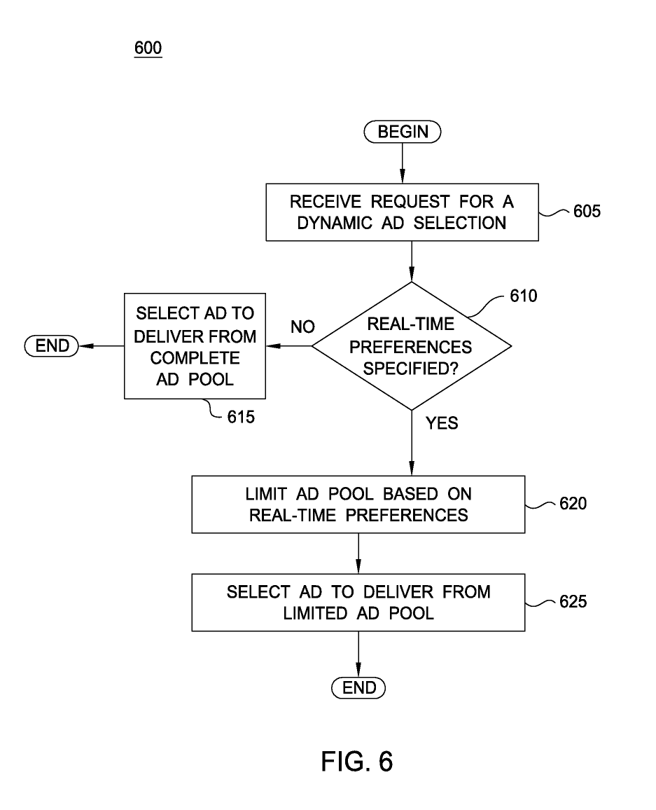

FIG. 6 illustrates a method 600 for an ad server platform to dynamically select an advertisement to present to a user during content playback, according to certain embodiments of the present disclosure. As shown, the method 600 begins at step 605, where an ad server platform receives a request for a dynamic ad selection to present to a user during a viewing session. At step 610, the ad server determines whether the request included any real-time advertising preferences (or whether such preferences have previously been received and cached on the server). If not, then at step 615, the ad server selects an ad to deliver to the client device from an available ad pool. However, if the user has specified any real-time preferences for ads presented during a viewing session, then at step 620, the ad server limits the available ad pool based on the real-time preference settings. At step 625, the ad server selects and ad to deliver to the client device form ads in the ad pool, as limited by the real-time preferences.

FIG. 7 illustrates an example of a web-based interface used to specify real-time advertising preferences, according to certain embodiments of the present disclosure. As shown, a web page 702 has been rendered in a browser window 700. The web page 702 includes a playback window 720, controls 705 and preference settings 725. The playback window 720 is used to present media content to the user. As noted, media content could include video streamed from a media streaming service (including both live and recorded video presentations), content from a video sharing website or content previously downloaded, recorded, or otherwise stored on the client device. Additionally, browser window 702 includes a frame 730 used to display banner ads requested from an ad server. The controls 705 allow a user to start, pause, fast-forward, and rewind content, as well as swap between an in-window presentation and a full screen view of the media content presented in playback window 720. When viewed full screen, the selection of any interstitial advertisements is governed by the real-time preferences set by the user (provided checkbox 710 is checked. Similarly, in a windowed mode, selection of any ads presented in the frame 730 is governed by the real-time preferences set by the user.

Controls 725 allow the user to specify ad preferences in real-time. In this example, a check-box 710 allows the user to toggle whether ads presented during a viewing session are limited. Of course, for other embodiments, other interface devices could be used. For example in the case of a set top box or HTPC configured to provide streaming media, a remote control could be configured with a button that toggled real-time ad selection preferences on (or off). Link 715 may be used to specify preferences for how ads are limited when the checkbox 710 is selected. For example, as noted above, the preferences may be based on ad ratings, identifying an age appropriate value for the content (or product) associated with a given ad, as well as preferences based on categories. Of course, a variety of different categories of personalization may be specified, for example, the preferences could be based on “child appropriate” or family-friendly” or “children ages 2-8.” Similarly, the preferences could be keyed to time of day or a different channel being viewed or could be associated with a user account with a given streaming media service. However specified, once the checkbox 710 is selected, any ads presented during the viewing session are governed by the user's preferences and the user's real-time selection of such preferences.

Thus, advantageously, embodiments described herein allow users to control the nature of ads that are presented during a viewing session in real-time, i.e., depending on their current viewing situation. Thus, embodiments described herein allow consumers to make real-time selections of the nature and category of advertisements presented when consuming advertising-supported media content, e.g., when viewing media from video-streaming service using a set-top cable box or HTPC.

While the foregoing is directed to embodiments of the present disclosure, other and further embodiments of the disclosure may be devised without departing from the basic scope thereof. For example, aspects of the present disclosure may be implemented in hardware or software or in a combination of hardware and software. One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present disclosure, are embodiments of the present disclosure.

In view of the foregoing, the scope of the present disclosure is determined by the claims that follow.

We claim:

1. A method, comprising:
during a viewing session for presenting media content to a user via a client device, receiving an indication of preferences for advertisements to be presented during the viewing session;
receiving a request for an advertisement to present to the user on the client device;
selecting, based on the received preferences, a first advertisement to present to the user; and
causing the first advertisement to be returned to the client device.

2. The method of claim 1, further comprising,
during the viewing session, receiving an update to the preferences for advertisements presented during the viewing session;
selecting, based on the updated preferences, a second advertisement to present to the user; and
returning the second advertisement to the client device.

3. The method of claim 1, wherein the advertisement is presented as an interstitial advertisement interrupting the presentation of the media content to the user.

4. The method of claim 1, wherein the advertisement is presented to the user concurrently with the presentation of the media content.

5. The method of claim 1, wherein the media content is supplied by a streaming media service.

6. The method of claim 1, wherein the media content is stored on the client device.

7. The method of claim 1, wherein the preferences specify one or more preferred ratings for advertisements presented during the viewing session

8. The method of claim 1, wherein the preferences specify one or more preferred categories for advertisements presented during the viewing session.

9. The method of claim 1, wherein the indication of preferences is received from the client device.

10. A computer-readable storage medium storing instructions capable of being executed by a processor, which, when executed, perform an operation, comprising:
during a viewing session for presenting media content to a user, receiving an indication of preferences for advertisements to be presented during the viewing session;
receiving a request for an advertisement to present to the user;
selecting, based on the received preferences, a first advertisement to present to the user; and
causing the first advertisement to be returned to a client device.

11. The computer-readable storage medium of claim 10, wherein the operation further comprises,
during the viewing session, receiving an update to the preferences for advertisements presented during the viewing session;
selecting, based on the updated preferences, a second advertisement to present to the user; and
returning the second advertisement to the client device.

12. The computer-readable storage medium of claim 10, wherein the advertisement is presented as one of an interstitial advertisement interrupting the presentation of the media content to the user and a banner advertisement presented to the user concurrently with the presentation of the media content.

13. The computer-readable storage medium of claim 10, wherein the preferences specify one or more preferred ratings for advertisements presented during the viewing session

14. The computer-readable storage medium of claim 10, wherein the preferences specify one or more preferred categories for advertisements presented during the viewing session.

15. The computer-readable storage medium of claim 10, wherein the indication of preferences is received from the client device.

16. A system, comprising:
a processor; and
a memory storing one or more application programs, which, when executed on the processor, are configured to perform an operation, comprising:
during a viewing session for presenting media content to a user, receiving an indication of preferences for advertisements to be presented during the viewing session,
receiving a request for an advertisement to present to the user,
selecting, based on the received preferences, a first advertisement to present to the user, and
causing the first advertisement to be returned to a client device.

17. The system of claim 16, wherein the operation further comprises:
during the viewing session, receiving an update to the preferences for advertisements presented during the viewing session;
selecting, based on the updated preferences, a second advertisement to present to the user; and
returning the second advertisement to the client device.

18. The system of claim 16, wherein the advertisement is presented as one of an interstitial advertisement interrupting the presentation of the media content to the user and a banner advertisement presented to the user concurrently with the presentation of the media content.

19. The system of claim 16, wherein the preferences specify one or more preferred ratings for advertisements presented during the viewing session

20. The system of claim 16, wherein the preferences specify one or more preferred categories for advertisements presented during the viewing session.
